(19) United States
(12) Patent Application Publication
(10) Pub. No.: US 2013/0055282 A1
(43) Pub. Date: Feb. 28, 2013

(54) TASK MANAGEMENT METHOD FOR EMBEDDED SYSTEMS

(71) Applicant: Sangho YI, Seoul (KR)

(72) Inventor: Sangho YI, Seoul (KR)

(73) Assignee: Samsung Electronics Co., Ltd., Suwon-si (KR)

(21) Appl. No.: 13/591,931

(22) Filed: Aug. 22, 2012

Related U.S. Application Data
(60) Provisional application No. 61/526,068, filed on Aug. 22, 2011.

(30) Foreign Application Priority Data
Aug. 22, 2012 (KR) 10-2012-0092007

(51) Int. Cl. G06F 9/50

(52) U.S. Cl. 718/104

(57) ABSTRACT

The present invention relates to a task management method and, in particular, to a task management method for efficiently managing task in resource constrained embedded systems where a Memory Management Unit does not exist. In accordance with an aspect of the present invention, a task management method for an embedded system, comprising designing a task management according to a short term task and a long term task; managing stack spaces for the short term task and the long term task; scheduling a time and a space for the short term task and the long term task; performing an adaptive stack management based on stack profiling; providing a uniform programming model for the short term task and the long term task; and implementing the short term task and the long term task

### PRIORITY

This application claims priority under 35 U.S.C. §119 to U.S. Provisional Application No. 61/526,068, which was filed in the U.S. Patent and Trademark Office on Aug. 22, 2011, and to Korean Application Serial No. 10-2012-0092007, which was filed in the Korean Industrial Property Office on Aug. 22, 2012, the content of each of which is hereby incorporated by reference.

### BACKGROUND OF THE INVENTION

1. Field of the Invention

The present invention relates to a task management method and, in particular, to a task management method for efficiently managing task in resource constrained embedded systems where a Memory Management Unit does not exist.

2. Description of the Related Art

In these days, rapid advancement of computer technologies has enabled us to use embedded systems on our real lives. The embedded systems are very small and dedicated purpose computing systems, so that they can pervade into lots of things such as buildings, forest, handheld devices, jewels, and even very thin papers. This feature makes the embedded systems to be resource-constrained, and thus, operating systems running on them should be aware of constraints including limited energy, computing power, and very small memory space. Recently, both event-driven and multithreaded task management schemes and some variations have been made to provide better resource utilization on such embedded systems. However, both events and threads have some disadvantages, and their variations can be used in very specific conditions.

### SUMMARY OF THE INVENTION

The present invention has been made in an effort to solve the above problems and it is an object of the present invention to provide a method and apparatus for controlling the data update periods of the applications running on the terminal effectively.

Aspects of the present invention are to provide a task management method for efficiently managing task in resource constrained embedded systems where a Memory Management Unit does not exist.

Another aspect of the present invention is to provide a new task management method for combined mechanisms managing multi-threads and event driven tasks.

Still another aspect of the present invention is to provide a task management able to enhance efficiency and performance in resource utility, and remove stack overflow problems in resource constrained embedded systems where a Memory Management Unit does not exist.

In accordance with an aspect of the present invention, a task management method for an embedded system, comprising designing a task management according to a short term task and a long term task; managing stack spaces for the short term task and the long term task; scheduling a time and a space for the short term task and the long term task; performing an adaptive stack management based on stack profiling; providing a uniform programming model for the short term task and the long term task; and implementing the short term task and the long term task.

Preferably, the character input method may be implemented with programs that can be executed by a processor, which are stored in a computer-readable recording media.

### BRIEF DESCRIPTION OF THE DRAWINGS

FIG. 1 is a diagram illustrating comparison of event-driven and multithreaded systems;

FIG. 2 is a diagram illustrating a brief structure of the event-driven task management;

FIG. 3 is a diagram illustrating a brief structure of multi-threaded task management;

FIG. 4 is a diagram illustrating Example of Thread's Stack Space Usage on Nano-Qplus;

FIG. 5 is a diagram illustrating An Example of Thread's Stack Space Usage on Nano-Qplus;

FIGS. 6 and 7 are diagrams illustrating brief Structure of PreeMe;

FIG. 8 shows an example of managing stacks on the SSMT mechanism when thread context switching is occurred;

FIG. 9 shows comparison of the Lazy-RR and the normal round-robin scheduling mechanism;

FIG. 10 shows how the adaptive stack management affects preemption points between tasks;

FIG. 11 shows comparison of programming models for event driven and multi-threaded;

FIG. 12 shows eThread's uniform programming model according to an embodiment of the present invention;

FIG. 13 shows building process of the eThread task management according to an embodiment of the present invention;

FIG. 14 shows Sensor Applications used in an embodiment of the present invention;

FIGS. 15 and 16 show amounts of allocated stack space for a sensor node according to an embodiment of the present invention;

FIG. 17 shows total execution time for a sensor node according to an embodiment of the present invention;

FIG. 18 shows Number of Context Switching Between Tasks for a sensor node according to an embodiment of the present invention;

FIG. 19 shows Amount of Allocated Stack Space for a sensor node according to an embodiment of the present invention;

FIG. 20 shows space-time product for a sensor node according to an embodiment of the present invention.

### DETAILED DESCRIPTION OF EXEMPLARY EMBODIMENTS

The operation principle of the present invention is described hereinafter with reference to accompanying drawings. Detailed description of well-known functions and structures incorporated herein may be omitted to avoid obscuring the subject matter of the present invention. Further, the following terms are defined in consideration of the functionality in the present invention, and may vary according to the intention of a user or an operator, usage, etc. Therefore, the definition should be made on the basis of the overall content of the present specification.

In the present invention, we compare the event-driven and the multi-threaded task management schemes in many aspects. Then, we present the design of yet-another task management for the resource-constrained embedded systems, which is neither event-driven nor multi-threaded. Our experimental results show that the proposed task management scheme provides better performance compared with the existing task management schemes.

In the most recent years, computer technologies have significantly changed people's real lives. They enabled us to use small embedded devices such as mobile handheld devices, wearable computers, and even wireless sensor networks which monitor huge environments. For example, wireless sensor nodes are used in the forest and mountains to detect fire [15], and MP3 players are embedded in several sports wears such as sunglasses, jackets, and running shoes [2]. In addition, a typical top-of-the-range automobile has more than 100 micro sensors to monitor the entire vehicle components [18].

Generally, the embedded devices have a few dedicated purposes, and they consist of very limited hardware components to minimize their production cost. In case of wireless sensor nodes, Berkeley's MicaZ has one 8 bit microprocessor, 4 KB SRAM, low-power R/F module, and 2 alkaline batteries. Such resource constraints are much more severe than general purpose computing systems. For example, a personal computer typically has 1˜4 GB space as the main memory, and there are about 1 million imes gap between them. This made the system software and operating systems running on the embedded devices to be more aware of the severe resource constraints. In the history of computer science, many operating systems have been developed for both the general-purpose and the special-purpose computer systems such as embedded computing devices. They can be categorized into two classes according to how the internal kernel structures were designed, and how they manage resources in the computer systems. Historically, the names of the two classes were defined as follows: message oriented (event-driven), and procedure-oriented (multi-threaded)[23]. For the past several decades, many discussions have been made on the two canonical models of the operating systems[10,12,17,1,21,8]. In 1978, Lauer and Needham presented the duality between the event-driven and the multi-threaded operating systems [12]. In their work, they concluded that the two classes are duals in terms of characteristics, operation, and the system's performance.

In theoretical point of view, above conclusion is correct. However, in the real implementations, the two classes show significant difference on performance and efficiency of the systems and their applications. The following are the pros and cons of the event-driven and the multi-threaded systems when implementing embedded operating systems. The design of the event-driven system provides small context switching overhead, much less memory space usage based on single stack sharing mechanism. However, average response time, scheduling latency, and preemptivity are much poorer than that of the multithreaded system [17]. The design of the multi-threaded provides fully-preemptible task management. But necessary memory space is much larger than the event-driven system because each thread requires its own stack space [21].

Considerable efforts have been made to design networked embedded operating systems under severe resource constraints of the embedded devices. They also can be categorized into the two aforementioned classes. TinyOS [13], SOS [9], PEEROS [16], CORMOS [22], and Contiki [5,4] are event-driven operating systems, while MANTIS OS [3], Nano-Qplus [13], and RETOS [11] are multi-threaded operating systems. The pros and cons on the event-driven and the multithreaded still exist in their works. When using the event-driven operating systems, software developers should be careful not to write locking operations on event handlers. In case of using the multi-threaded operating systems, the developers must understand how much memory space is required for allocating threads' stacks, and how much space is available in the system.

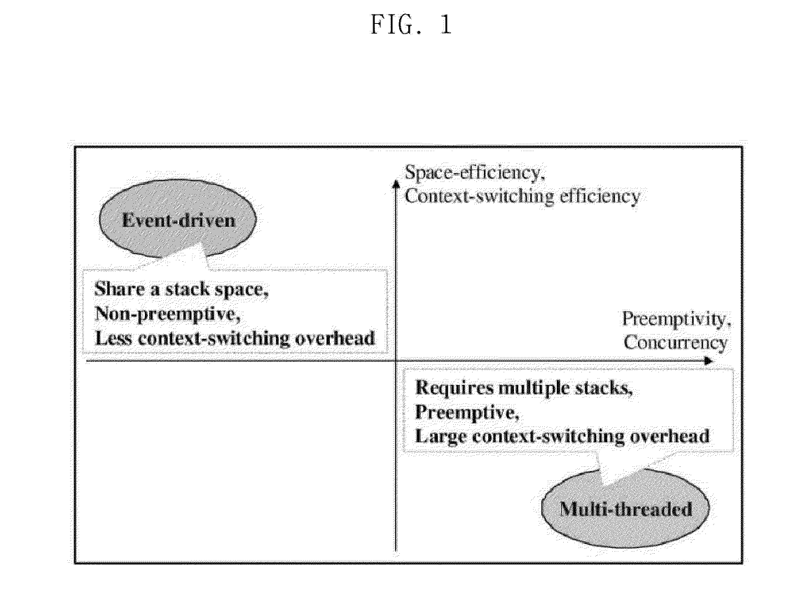

FIG. 1 is a diagram illustrating comparison of event-driven and multithreaded systems.

As depicted in FIG. 1, to alleviate above problems and developer's sufferings, several research works were made for the networked embedded operating systems. SESAME and SESAME-P provide space-efficient stack allocation mechanism for multi-threaded sensor operating systems. PreeMe [27] and PreeMe-X [25] supports fully-preemptive task management on event-driven sensor operating systems. However, the schemes are premature, and they can be adopted in very limited applications which meet specific conditions. Accordingly, in the present invention, comparison of the event-driven and the multi-threaded system structures on resource-constrained embedded systems are shown in many aspects. Hereinafter, from the comparison results, the reason that both the event-driven and the multithreaded are not enough to implement efficient embedded operating systems is presented. Then, a new system structure, eThread, which is designed for the resource-constrained embedded systems is proposed.

The eThread is a portmanteau of the Thread and Event, and is a combination of the event-driven and the multithreaded task management structures. The present invention implements the prototype version of eThread on actual embedded sensor platform. The experimental results show that eThread provides better efficiency, performance, and programmability compared with the existing task management schemes.

Next, some related works on networked embedded operating systems and their variations are presented, and comparison of the event-driven and multi-threaded operating system structures is described in terms of both performance and characteristics. Then, the design and implementation of eThread is presented in detail. Also, performance of the eThread and the existing event-driven and multi-threaded task management schemes is evaluated and, finally, according to the embodiments of the present invention, some conclusions and future work are presented.

1. Previous Work

In this section, existing works related to the networked embedded operating systems and mechanism proposed by the present invention, are briefly presented as follows. That is, lots of researches have been made on developing embedded operating systems and resource management schemes under severe resource constraints. The following subsections describe the existing works in detail.

1.1 Event-Driven vs. Multi-Threaded

In the recent several decades, many researchers had argued performance and efficiency of the event-driven and the multithreaded task management schemes. In H. C. Lauer and R. M. Needham, On the duality of operating system structures, In Second International Symposium on Operating Systems, IRIA, (1978), Lauer and Needham concluded that the two schemes are duals, and both have equivalent features and functionalities theoretically. After several years, however, some other researchers found that the real implementations of the event-driven and the multi-threaded task management show significantly different performance in terms of throughput, task scheduling, and concurrency.

In J. K. Ousterhout, Why threads are a bad idea (for most purposes), Presentation given at the 1996 Usenix Annual Technical Conference, (1996), Ousterhout argued several disadvantages of the multi-threaded task management by showing results of actual examples of the event-driven and multi-threaded systems. He also presented that the multi-threaded task management is better than the event-driven when a target system is susceptible to the response time, concurrency, and/or preemptivity of running tasks.

In A. Adya, J. Howell, M. Thiemer, W. J. Bolosky, and J. R. Douceur, Cooperative task management without manual stack management, In Proceedings of the 2002 USENIX Annual Technical Conference, (2002), Adya et al. suggested a sweet spot hybrid task management model of the two existing schemes (event-driven and multi-threaded). The authors insisted that the sweet spot, which provides cooperative task processing without manual stack management, can be implemented based on continuation and stack ripping mechanisms. However, they failed to present how to implement it, and the expected overhead of the continuation and the stack ripping mechanisms.

In R. Von Behren, J. Condit, and E. Brewer, Why events are a bad idea (for high-concurrency servers). In HotOS IX: The 9^{th} Workshop on Hot Topic in Operating Systems, pp. 19-24, (2003)) evaluated performance of the real implementations of the event-driven and the multi-threaded task management. Based on the results, they insisted that the efficiency of the multi-threaded operating systems can be improved by several compiler-assisted techniques.

In A. Gustafsson, Threads without the pain, ACM Queue 3, pp. 34-41, (2005), Gustafsson describes the concept of the stackless multi-threading implementation in C/C++ programs to reduce memory space requirement. In the stackless implementation, all running functions have their own stack frame space allocated from the heap memory space, and they are managed as linked lists data structure.

1.2 Existing Operating Systems for Resource-Constrained Embedded Systems

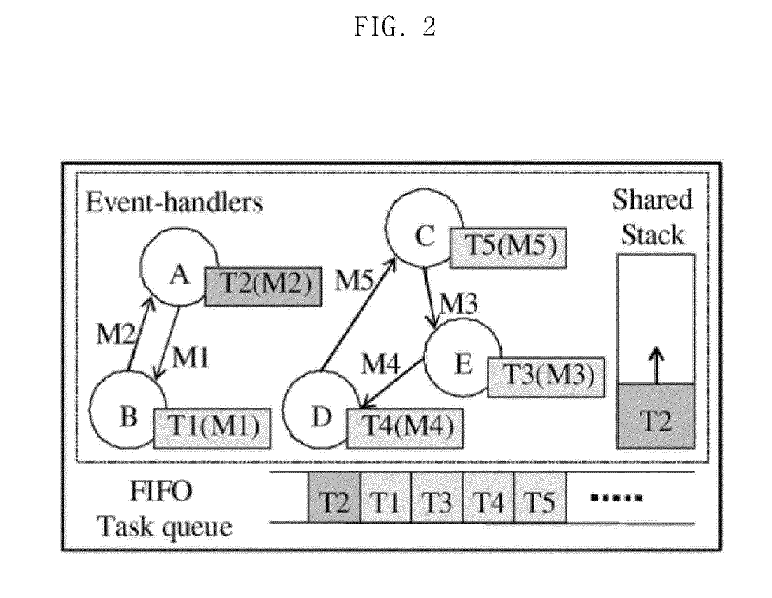

FIG. 2 is a diagram illustrating a brief structure of the event-driven task management.

Recently, several embedded operating systems were developed for severely resource constrained embedded systems. Also, their variations were made to improve them in terms of memory space-efficiency, preemptivity, energy-efficiency, and etc. These examples are shown in FIG. 2.

In P. Levis, S. Madden, D. Gay, J. Polastre, R. Szewczyk, A. Woo, E. Brewer, and D. Culler, The emergence of networking abstractions and techniques in TinyOS, In First USENIX/ACM Symposium on Networked Systems Design and Implementation (NSDI)(2004)), Levis et al. proposed a TinyOS, which is an embedded operating system for wireless sensor networks. TinyOS was developed by UC Berkeley's research team, and is the most well-known operating system for tiny sensor nodes. It adopts the event-driven task management, and thus, event tasks are scheduled by First In First Out (FIFO) manner, and tasks share one stack space.

In C.-C. Han, R. Kumar, R. Shea, E. Kohler, and M. B. Srivastava, A dynamic operating system for sensor nodes, In The 3^{rd} International Conference on Mobile Systems, Applications, and Services (MobiSys), pp. 163-176, (2005)), Han et al. proposed a SOS operating system for sensor embedded systems. Similar to the TinyOS, it uses event-driven task management, and tasks are scheduled by FIFO with priority. Due to the FIFO scheduling mechanism, TinyOS and SOS have very fixed preemption points. If a running task requires relatively much longer execution time, then the other tasks should be waiting for finishing execution of the running task.

In A. Dunkels, B. Gronvall, T. Voigt, Contiki—a lightweight and flexible operating system for tiny networked sensors, In The 1st IEEE Workshop on Embedded Networked Sensors (EWSN), (2004).) and A. Dunkels, N. Finne, J. Eriksson, and T. Voigt, Runtime dynamic linking for reprogramming wireless sensor networks, In The 4th ACM Conference on Embedded Networked Sensor Systems (SENSYS), (2006)), Dunkels et al. proposed a Contiki operating system for networked embedded and sensor systems. Contiki provides a Protothreads mechanism [6] which enables a user-level thread programming method. But, the Protothreads is not the solution to provide multi-threading on sensor nodes, but a programming sugar of event-driven programming. It does not allow preemption and automatic state management between threaded tasks.

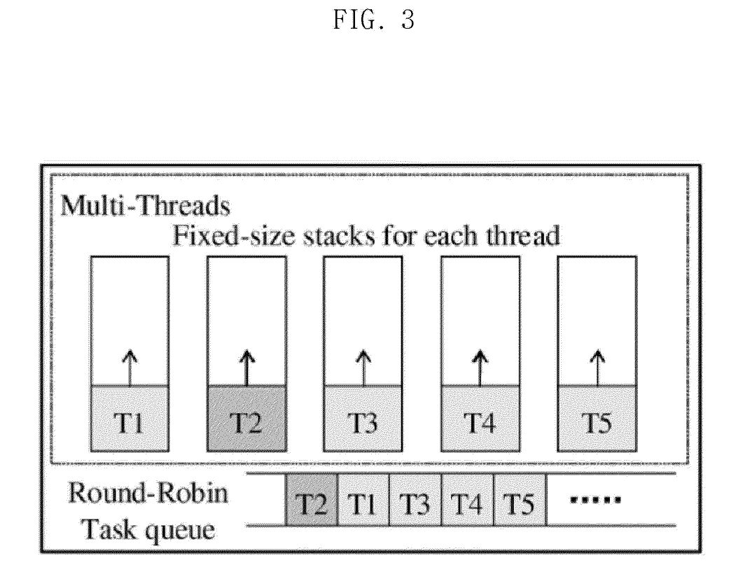

FIG. 3 is a diagram illustrating a brief structure of multi-threaded task management.

To avoid the disadvantages on the event-driven, several researchers developed multi-threaded embedded operating systems including MANTIS OS, Nano-Qplus, and RETOS. MANTIS OS supports preemptive multi-threading, so it can handle various tasks and events from sensors concurrently.

In addition, it can process time-sensitive tasks by Round-Robin scheduling mechanism. Similar to MANTIS OS], Nano-Qplus and RETOS adopted the multi-threaded task management as shown in FIG. 3 to provide preemptive task scheduling. In these operating systems, however, each thread should have its own stack space. It inefficiently consumes memory space on the space constrained embedded systems such as sensor nodes. Such memory usage may incur several problems of the space inefficiency and stack overflow.

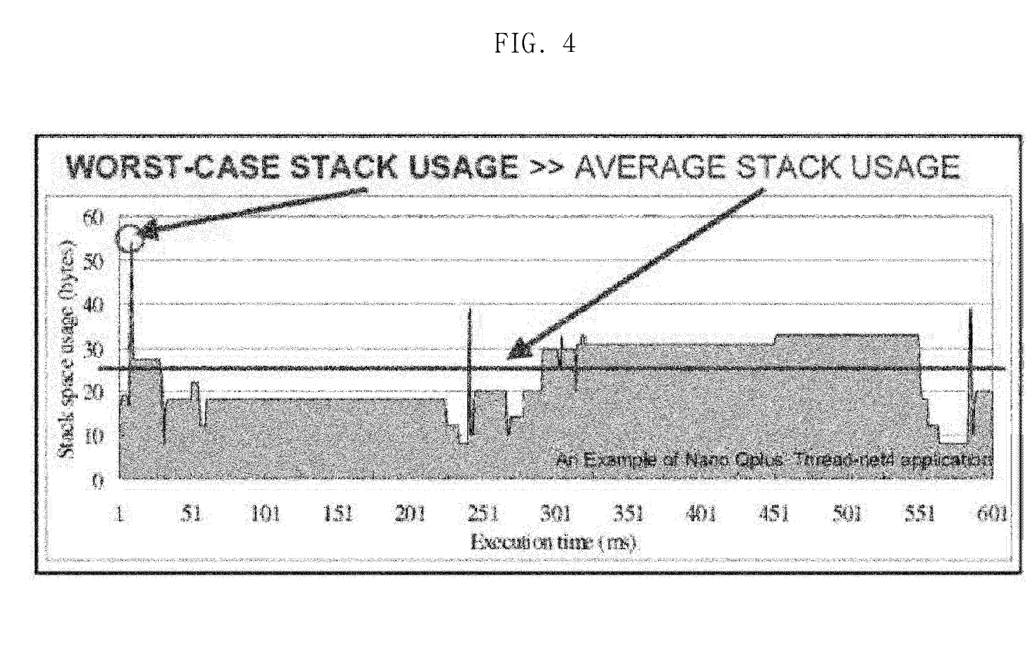

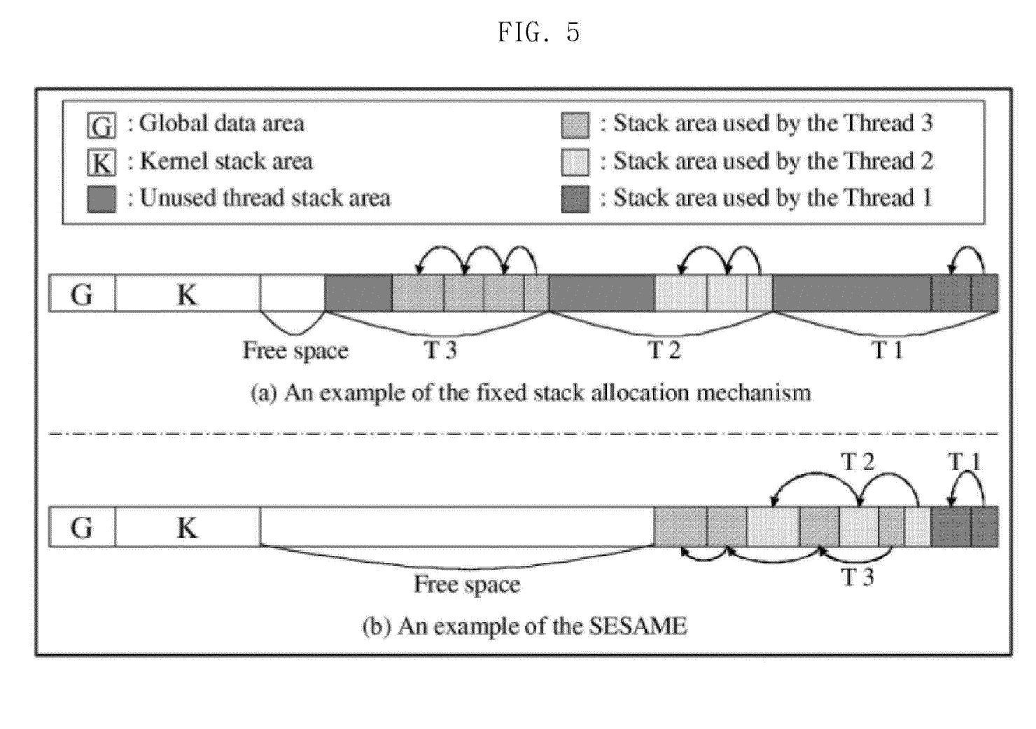

Several mechanisms were proposed to alleviate such problems on both the event-driven and the multi-threaded embedded operating systems. The mechanisms will be described referring to FIGS. 4 and 5.

FIG. 4 is a diagram illustrating Example of Thread's Stack Space Usage on Nano-Qplus and FIG. 5 is a diagram illustrating An Example of Thread's Stack Space Usage on Nano-Qplus.

In Torgerson (R. Von Behren, J. Condit, and E. Brewer, Why events are a bad idea (for high-concurrency servers). In HotOS IX: The 9^{th} Workshop on Hot Topic in Operating Systems, pp. 19-24, (2003)), Torgerson proposed a fixed stack management for MANTIS OS based on the compile-time calculation of the upper-bound of the thread's stack requirement. Then, the scheme statically allocates a stack space with fixed-size. In this way, it can reduce the unnecessarily allocated stack space. However, the scheme cannot be used when recursion or pointer functions are called on the source codes. In addition, as the result of FIG. 4, the worst-case stack usage is typically much larger than average stack usage. If the fixed stack management is used in the example on FIG. 4, it should allocate at least 55 bytes. Then, more than 50% of the allocated stack space will not be used after 10 seconds of thread's execution.

In S. Yi, H. Min, S. Lee, Y. Kim, I. Jeong, and S. Y. Shin, SESAME: Space-efficient stack allocation mechanism for multi-threaded sensor operating systems, In ACM Symposium on Applied Computing (SAC), pp. 1201-1202, (2007), and S. Yi, S. Lee, Y. Cho, and J. Hong, OTL: On-demand thread stack allocation scheme for real-time sensor operating systems, Lecture Notes in Computer Science 4490, pp. 905-912, (2006), Yi et al. proposed a SESAME, which is a space efficient stack allocation mechanism for multi-threaded sensor operating systems. SESAME enables to adaptively adjust stack size by allocating or releasing additional stack frame based on the amount of each function's stack usage information. The information is calculated at compile-time, and the adaptive stack space adjustment occurs at run-time. In this way, the space-efficiency is significantly improved compared with the fixed stack management. However, SESAME may degrade overall performance of the target systems because it performs stack allocation and releasing operations at every call and ret instructions. To reduce such overhead, the authors proposed a SESAME-P, which is a memory Pool-based SESAME.

By using predetermined memory pool structures, SESAME-P reduced execution time consumed on memory allocation and releasing operations.

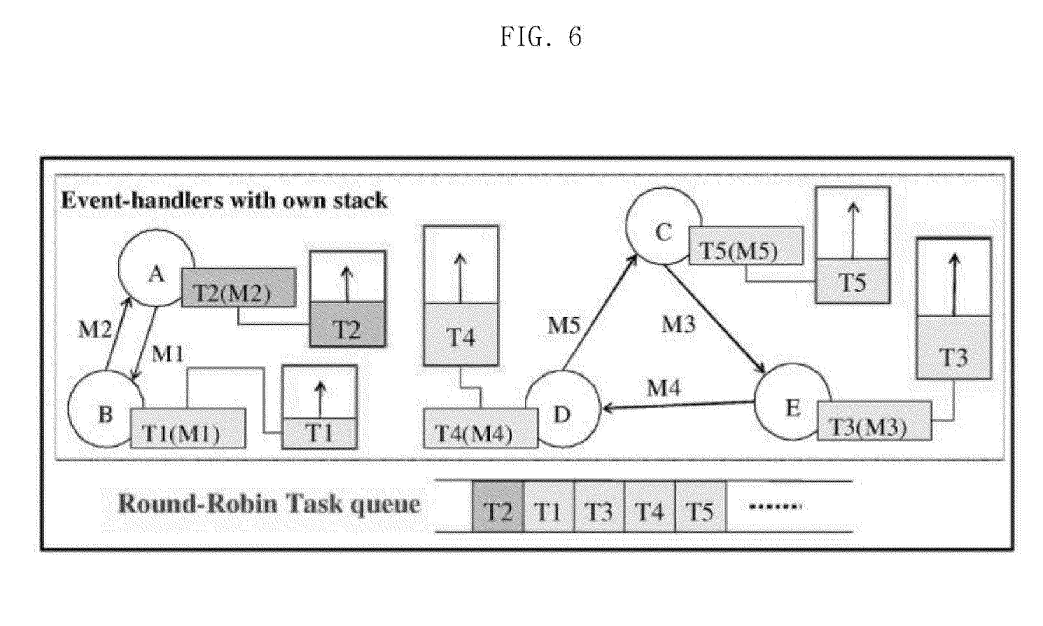

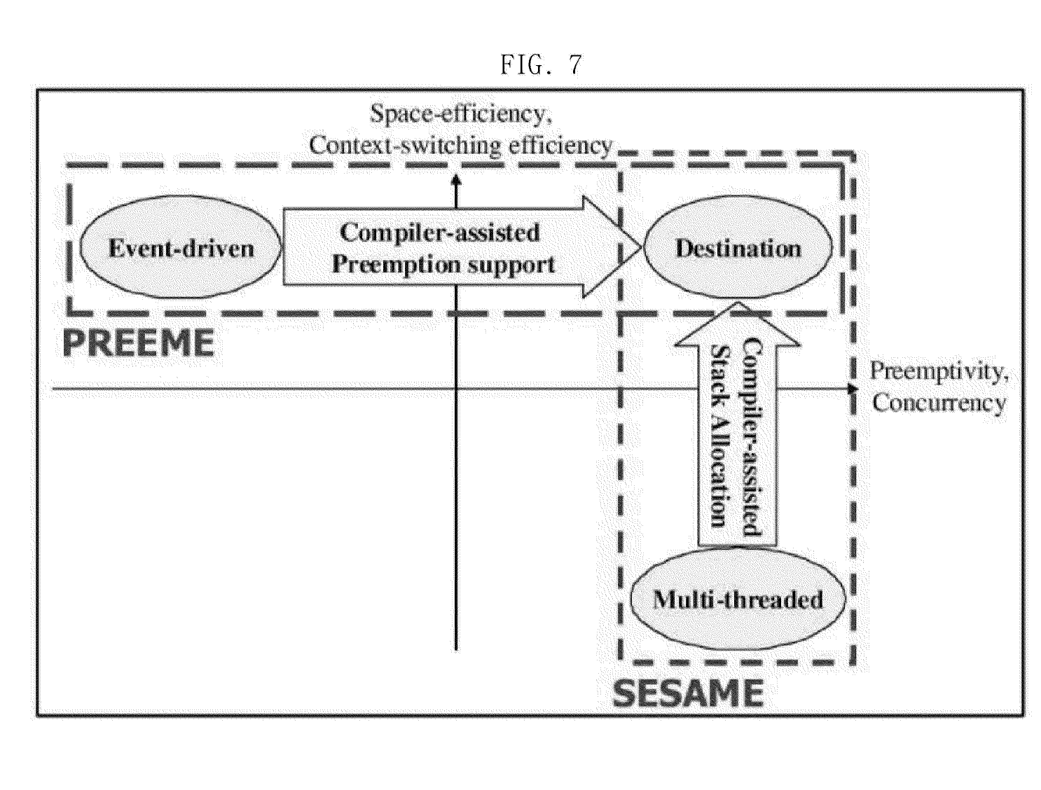

FIGS. 6 and 7 are diagrams illustrating brief Structure of PreeMe.

In S. Yi, H. Min, Y. Cho, I. Jeong, Y. Kim, B. Lee, and J. Choi, PreeMe: Preemptive real-time task management for event-driven sensor operating systems, In 2008 ACM Symposium on Applied Computing (SAC), pp. 1726-1727, (2008), Yi et al. proposed a preemptive task management for event-driven sensor operating systems, called PreeMe. It dynamically manages stack space for each event handling task on demand to provide preemptiveness on the event-driven systems.

However, PreeMe does not consider efficiency of the task preemption, and thus, time overhead incurred by run-time context switching may degrade systems' performance. The authors also proposed a PreeMe-X, which provides both energy and space-efficient preemptive task managements for the event driven sensor operating systems. It determines the space efficient context switching points based on the stack usage profile. If a task needs to preempt the running task, PreeMe-X takes a context switching when the size of the running task's stack is relatively small.

The above schemes showed good performance and efficiency on the resource-constrained embedded systems. However, as the authors mentioned in their papers, the previous schemes can be adopted in very limited systems and applications which meets specific conditions.

2. Design of Yet-Another Task Management Structure for Resource-Constrained Embedded Systems

Hereinafter, detailed comparison of the event driven and the multi-threaded task management are presented in many aspects. Then, requirements, and design principles of the new task management structure for resource-constrained embedded systems are presented. According to the embodiment of the present invention, design and prototype implementation of the new task management, eThread, are presented in detail.

2.1 Comparison of Events and Threads in More Detail

2.1.1 Memory Space Usage

| Feature | Event-driven | Multi-threaded |
|---|---|---|
| Number of stack space | one stack | many stacks (number of |
| | | threads) |
| Context switching cost | function calling & | TCB saving & restoring |
| | returning cost | cost |
| Task creation & deletion | — (nothing special) | dynamic memory alloc & |
| cost | | free cost |
| Preemptible (yieldable) | very limited points | every point of execution |
| points | | |
| Scheduling latency | (relatively) high | (relatively) low |
| Real-time scheduling | hard to provide | easy to provide |

Table 1 presents characteristics of the event-driven and the multi-threaded task management. The event-driven task management requires just one stack space because there is only one execution flow. On the other hand, the multi-threaded management requires multiple stacks to provide multiple threads of execution. On resource-constrained embedded systems, such as wireless sensor nodes, they have a few KB space as the main memory, and they do not have memory management or protection unit. Therefore, when using the multi-threaded task management, how much memory space is required for each thread stack to remove stack overflow problem, should be considered.

2.1.2 Time Overhead

To compare the two task management schemes in terms of the execution time overhead is also needed. Generally, the multithreaded management has more time overhead than the event driven.

For example, each thread requires saving and restoring its TCB (thread control block) on context switching point because they did not finish their execution. However, in case of event handlers, context switching occurs only when the running task finishes its execution. For this reason, the event-driven task management has smaller overhead than the multi-threaded.

2.1.3 Preemptivity

Preemptivity is the most important criteria when evaluating design of the operating system structures. The multi-threaded system typically provides fully-preemptive task scheduling except some critical sections. On the other hand, the event driven system has the limited points to preempt the running task. The preemption on the event-driven is available only when the running task's priority is smaller than that of the next waiting task, and the reverse directional preemption is impossible. That's because all event tasks share one stack, and such structure cannot provide fully preemptive task management.

2.2 Requirements

Resource-constrained embedded systems typically consist of very limited hardware components. Table 2 shows some examples of the networked embedded sensor platform used in wireless sensor networks.

TABLE 2
Specification of Wireless Sensor Platforms

| | | | |
|---|---|---|---|
| Hardware | MicaDot | MoteIV | ESB |
| MCU | atmega128 | msp430f1611 | msp430f149 |
| Internal flash | 128 kB | 48 kB | 60 kB |
| External flash | 512 kB | 512 kB | — |
| SRAM | 4 kB | 10 kB | 4 kB |
| Radio(kbps) | CC1000 38.4 | CC2420 250 | TR1001 115.2 |
| Battery type & | Lithium 3B45 | Alkaline 2xAA | Alkaline 2xAA |
| size | | | |

In Table 2, sensor platforms show that the main memory space is extremely smaller than that of the general-purpose computing systems. It's about 1,000,000 times gap between the sensor platforms and current desktop computer systems. Moreover, many other kinds of resource-constrained embedded systems exist in the real-world applications (e.g. mobile handheld devices, wearable medical caring devices, and many other wireless communication devices). In those systems, memory space, computing power, and the power sources are very limited, and thus, the new task management for those systems should meet the following requirements.
Providing space efficient stack management to minimize memory space requirement of allocating multiple tasks' stack space
Minimizing execution time consumed by task management including context switching, stack space management, and task scheduling
Providing preemptive task management for improving performance, interactivity, and real-time response of the running tasks

There are three important requirements; space-efficient stack management, execution time minimization, and preemptive task management support. Especially, execution time is closely related to the energy-efficiency of the embedded systems. If time overhead by half is reduced, it may reduce the energy consumption on microprocessor significantly.

2.3 eThread: Yet-Another Task Management Structure—Neither Event-Driven Nor Multi-Threaded

Hereinafter, we propose a yet-another task management structure for resource-constrained embedded systems. eThread is a portmanteau of the two words, Thread and Event, which is neither event-driven nor multi-threaded task management. It provides both space and time-efficient and preemptive task management for both short-term tasks (event handlers) and long-term tasks (threads). Also, it supports a unified programming model on both the short-term and the long-term tasks for easier understanding and development.

2.3.1 Design Principles

In the present invention, we attempted to provide a unified view for two different tasks, events and threads. The event is a unit of tasks in the event-driven, and event handlers are the main task processing routines on the event-driven system. The thread is a task in the multi-threaded system, and each thread can perform unbounded loops because they can be preempted by other threads at anytime. Typically, events require very short time to handle events, and threads require much longer execution time. In other words, the events can finish their work in just few time slices, while the threads should have interleaved execution by some Round-Robin-like scheduling algorithms. In eThread task management, we virtually divided the events and the threads as follows.
Short-term tasks: transient tasks—similar to events
Long-term tasks: general tasks—similar to threads

Based on the virtual division, we defined several principles on designing eThread task management for the following items.
Time slice management: Provide flexible time slice for short-term tasks to execute them within one time slice if possible
Stack space management: Do not allocate and release own stack space for short-term tasks which may finish their work in one time slice
Context switching: Perform efficient context switching between long-term tasks based on stack usage information
Programming method: Provide a unified programming model and interface for both short-term and long-term tasks
Complexity minimization: Minimize complex implementation and managing process on both compile-time and run-time

2.3.2 Stack Space Management

In the present invention, a SSMT (shared stack-based multithreading) as the main stack management to follow above design principles can be used.

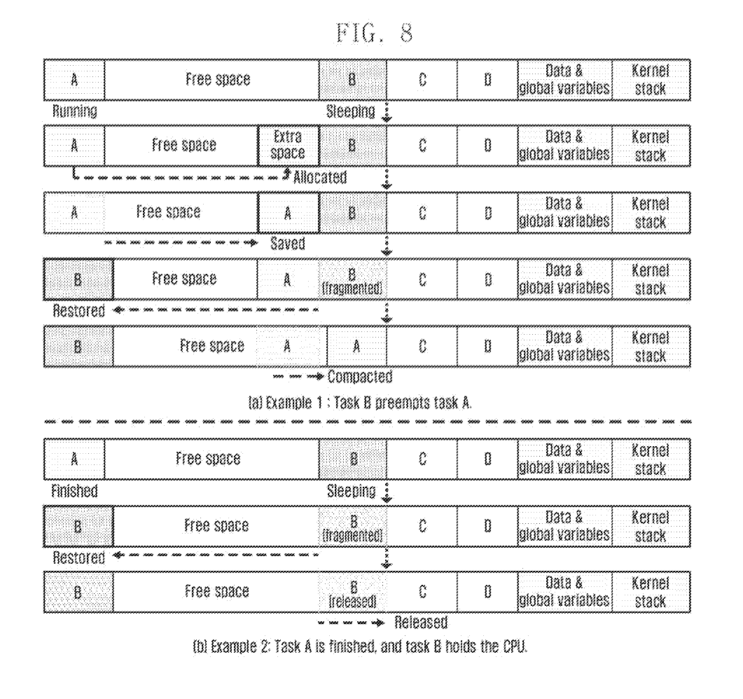

FIG. 8 shows an example of managing stacks on the SSMT mechanism when thread context switching is occurred.

In FIG. 8 (a), the running task is preempted by one waiting task. The running task's stack frame is saved to the allocated memory space, and the stack frame of the next task is copied to the leftmost part (end) of the heap memory space. SSMT can minimize the amount of allocated stack space for tasks, because it allocates only actually used space by the tasks. In addition, SSMT allocates stack space for each task on preemption. This means that SSMT can delay the stack allocation operation at the end of the time slice of the running task. In other words, when using SSMT, we do not need to allocate stacks for short-term tasks when they are scheduled in one time slice. FIG. 8 (b) shows the case when the running task is finished its execution in the time slice. In this case, the running task does not need its own stack space. We then reduce task managing cost by using above characteristics of SSMT.

2.3.3 Task Scheduling

a Lazy-RR1 scheduling mechanism which provides both time and space-efficient task management for the short and long-term tasks are proposed. Lazy-RR is different from the legacy round-robin on managing context switching points and time slices of each running task.

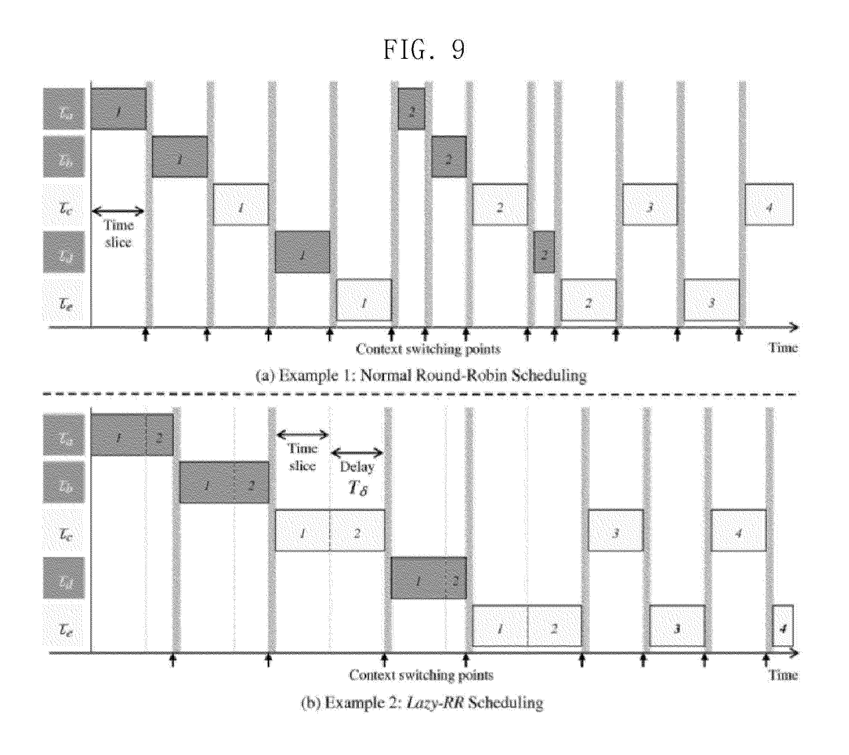

FIG. 9 shows comparison of the Lazy-RR and the normal round-robin scheduling mechanism.

In the present invention, the major difference between the normal and Lazy-RR comes from context switching points between runnable tasks. In the example of FIG. 9, τa, τb, and τd have relatively shorter time for execution than τd, and τe. In FIG. 9 (a), short term tasks (τa, τb, and τd) require at least 2 time slices when using the normal round-robin scheduling, because the time requirement of each task's execution is greater than the context switching period.

On the other hand, in FIG. 9 (b), Lazy-RR delays context switching within T_{delta} to reduce the context switching for the short-term tasks. By doing so, the task manager does not need to allocate stack space for the τa and τb, and we can reduce the allocation overhead for the τd. In the Lazy-RR, the same mechanism is used for long-term tasks (τC and τe) at the first round of execution. The first time slice of each long-term task will be increased by the time T_{delta}, and then each running task will be switched by the next task. Then, the Lazy-RR knows that the switched task still requires execution, and then the task is considered as a long-term task. After the first round, each long-term task is scheduled by the normal round-robin manner without delaying of T_{delta}.

2.3.4 Adaptive Stack Management Based on Stack Profiling

Stack space-efficiency by exploiting stack usage information of each task can be also increased. In our previous work, PreeMe-X provides efficient context switching points based on stack profiling mechanism. In the present invention, we used the same stack mechanism to minimize the amount of stack space.

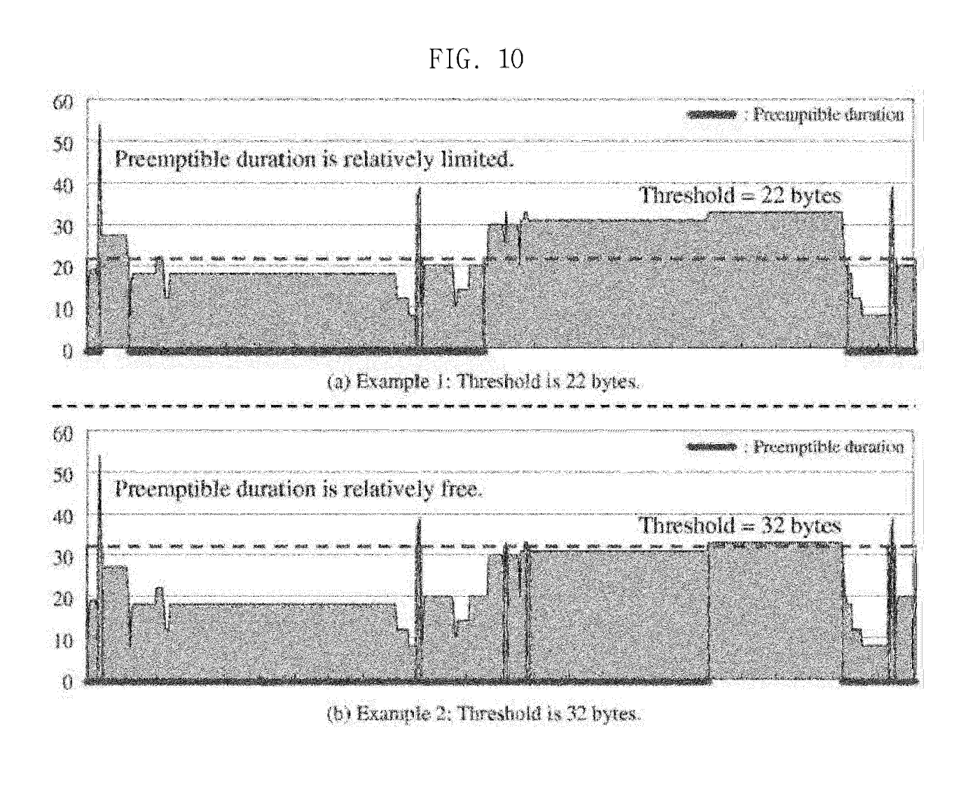

FIG. 10 shows how the adaptive stack management affects preemption points between tasks. By using predefined stack usage threshold, each running task can select appropriate context switching points. However, it has trade-off relation between preemptiveness and space-efficiency. For this reason, it is important to determine an appropriate threshold value.

2.3.5 Programming Model

Programming models for the event-driven and the multi-threaded task management schemes are firstly compared.

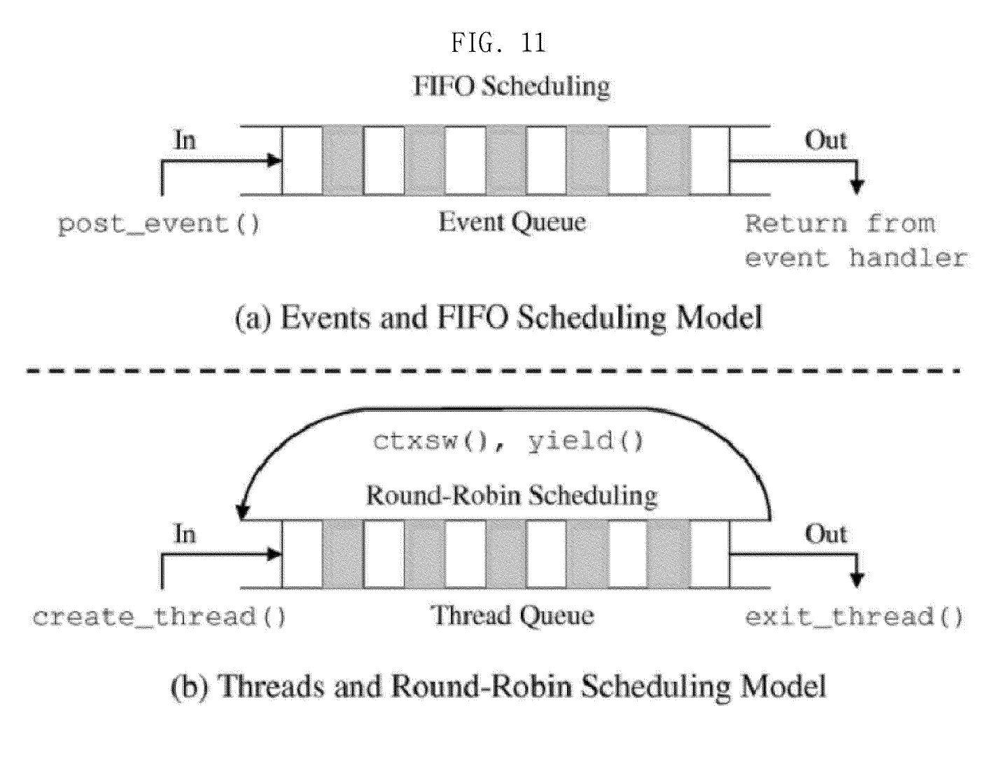

FIG. 11 shows comparison of programming models for event driven and multi-threaded.

In FIG. 11 (a), an event task is generated by post( ) and the tasks are just scheduled by FIFO manner. The event tasks finish their work when no other tasks with higher priority tasks are in the queue. When the event task finishes its work, then the task will be terminated on the system. In FIG. 11 (b), a thread task is created by create_thread( ) and exit_thread( ) terminates it. The threads are scheduled by round-robin manner, so that each thread is generally re-inserted into the queue.

In above comparison results, the events and the threads have relatively different programming interfaces, and each of them has its own characteristics. This makes the system development to be hard work, because the system engineers should aware of the characteristics of both event-driven and multi-threaded, different programming interfaces, and how to select an appropriate one for programming. To remove such problems, in the present invention, we provide the uniform programming model for both the short (event) and long-term (thread) tasks.

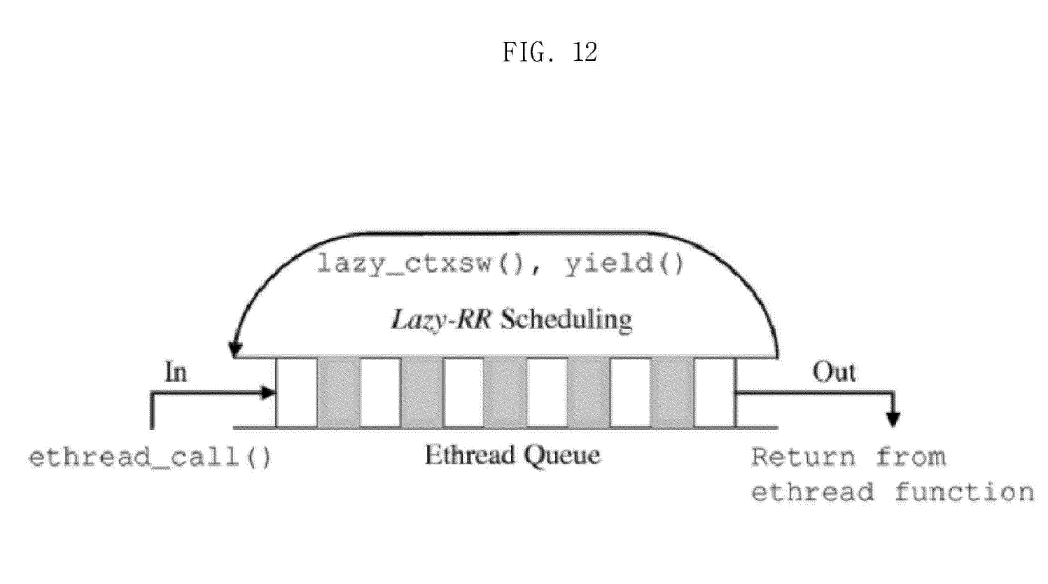

FIG. 12 shows eThread's uniform programming model according to an embodiment of the present invention.

When using eThread, we do not need to consider how long execution time is required for each task. In FIG. 12, every task can be created by ethread_call( ) and they are scheduled by the Lazy-RR scheduling mechanism. When the time slice of the running task is expired, it will be re-inserted into the queue. Based on the unified programming interface, eThread reduced the complexity on both design and implementation of system software for resource-constrained embedded systems.

2.4 Implementation of eThread

In this section, we present how to implement eThread task management for resource-constrained embedded systems. The prototype version of eThread and its several varieties on Nano-Qplus operating system for wireless networked embedded systems is implemented. The full source codes used in the present invention are available on the website.

2.4.1 Prototype Implementation

Nano-Qplus is a kind of multi-threaded operating systems. It has the normal round-robin scheduling mechanism with fixed stack management scheme. To provide eThread task management on top of the Nano-Qplus sensor operating system, new schemes and modified several existing components are implemented as follows.
Task management component: Implementation of Lazy-RR scheduling mechanism and modification of the previous task structures
Stack space management component: Implementation of Shared stack-based multi-threading (SSMT) structure component
Stack usage profiling component: Implementation of both run-time (on-line) and compile-time (off-line) stack usage profiler
Programming interface: Providing unified task creation, deletion, and managing interface for both short and long term tasks
Dynamic component prototyping support: Providing dynamic kernel configuration options as menuconfigstyle tool

To do the above, source codes of the latest version of Nano-Qplus (ver. 2.3.0), are modified and each newly added component can be easily configured by dynamic kernel configuration (dynamic prototyping) utility. We added two variables (nExec, nThres) for each task structure to implement Lazy-RR and adaptive context switching based on stack usage information.

The nExec denotes how many times a task has been scheduled by a processor. If the value is smaller than 2, the task will have extra time slice, and it continues its execution. By doing so, Lazy-RR performs delayed context switching. Then, some short-term tasks may finish their work in just one time slice without allocating and saving their own stack space on the heap memory. The nThres is used for denoting threshold value of each task's stack usage. If the stack usage of the running task is larger than nThres, the context switching will be skipped and retried at the next context switching point. If the context switching has been skipped for an reasonable duration, the scheduler performs context switching between tasks. In our implementation, we set the reasonable duration as the amount of the default (one) time slice.

In addition, we have been made several stack usage profilers for our previous works. However, in this work, such profiled results should be inserted into nThres by human programmers. We are now implementing automatic stack usage profiling and adapting toolkits, and it will be added in our future work of the present invention.

2.4.2 Building Process

This section presents a building process of the implemented eThread task management for actual wireless networked embedded sensor platforms.

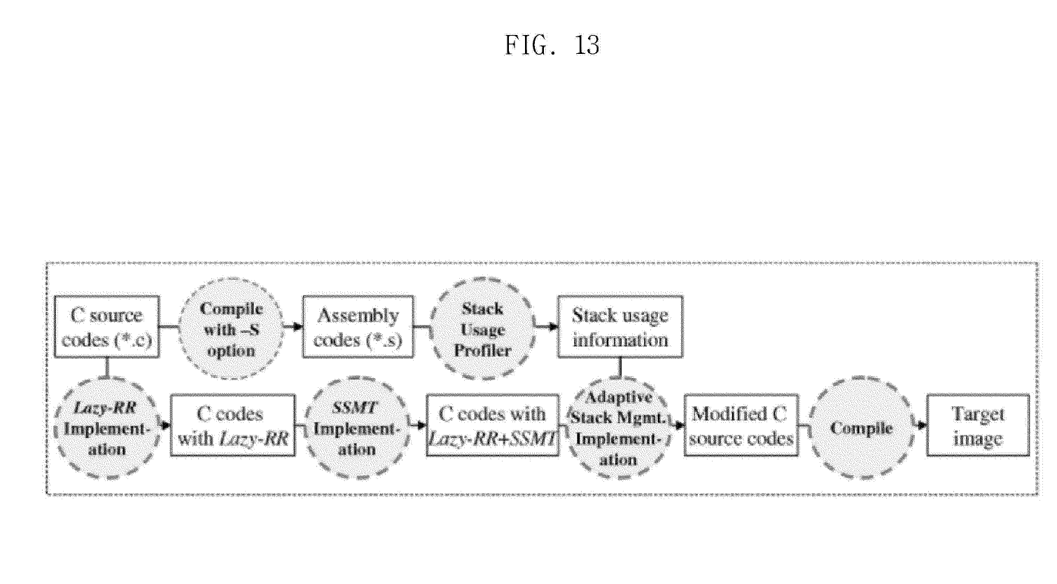

FIG. 13 shows building process of the eThread task management according to an embodiment of the present invention.

scheme. In this process, compile-time stack profiler calculates stack usage by analyzing assembly-level stack increment and decrement codes such as push and pop. Then, the stack usage report is used to add a C source code which initializes the nThres of each created task structures. Finally, the building process is ended by compiling the modified C source codes.

3. Performance Evaluation

In this section, we evaluate performance of eThread with various kinds of task management schemes in terms of the execution time, the amount of allocated stack space, and the spacetime product. We made several experiments based on Tmote Sky sensor platforms and existing applications of Nano-Qplus.

3.1 Experimental Setup

To evaluate various features of eThread task management scheme, we measured every combination of sub-components on eThread such as normal vs. lazy round-robin, fixed vs. shared stack management, and whether using stack profiling or not. The following are the combinations used in the present invention.
Normal+Fixed: This is the original Nano-Qplus and MANTIS OS′ task management scheme.
Lazy+Fixed: This performs Lazy-RR scheduling mechanism.
Normal+Shared: This provides SSMT for managing tasks' stacks.
Lazy+Shared: This performs Lazy-RR scheduling based on SSMT.
Normal+Fixed+Profiling: This performs selective context switching based on stack usage information.
Lazy+Fixed+Profiling: This performs selective context switching based on both Lazy-RR and stack usage information.
Normal+Shared+Profiling: This provides SSMT, and performs context switching based on stack usage information.
Lazy+Shared+Profiling: This is the eThread task management scheme proposed in the present invention.

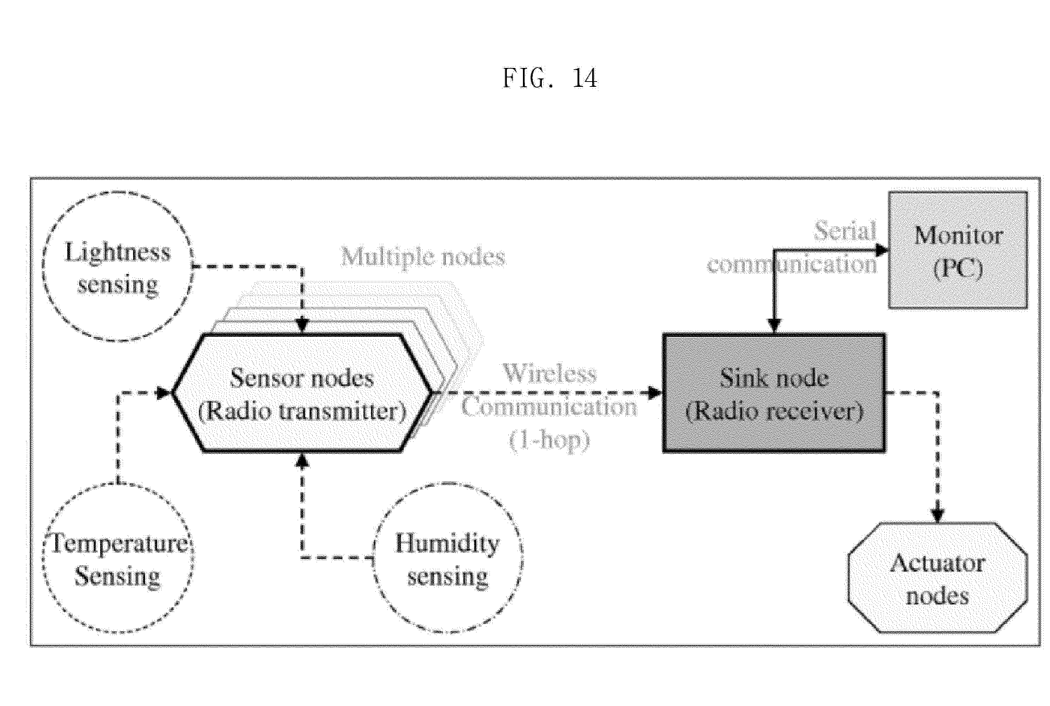

FIG. 14 shows Sensor Applications used in an embodiment of the present invention.

FIG. 14 and Table 3 present specification of the wireless sensor applications and Tmote Sky sensor hardware platform used in this paper.

TABLE 3
Specification of Tmote Sky Sensor Platform

| Hardware | Model | Description |
|---|---|---|
| CPU | TI MSP430F1611 | 16-bit MCU |
| Memory space | In-core flash | 48 kB |
| | External flash | 1 MB |
| | SRAM | 10 kB |
| | EEPROM | 128 B |
| R/F | CC2420 | 2.4 Ghz (250 kbps) |
| Power | 2 x AA Batteries | 2.4~3.0 Volts |

| | |
|---|---|
| Sensors | Humidity, Temperature, Ambient light |

In our performance evaluation, we used three kinds of nodes and one monitor (base station). Each sensor node performs sensing, and transmitting the sensed data to the sink node. Then the sink transmits the sensed data to the base station node via wired serial line, and it sends some commands to actuators. To do these works, each sensor node has 3 non-returning tasks, and creates 1 extra task when transmitting data to the sink node.

The sink node has 2 non-returning tasks and it creates a task when receiving data from a sensor node. In this application scenario, sensor and sink nodes has both long-term (non-returning) tasks and a short-term (packet transmitting/receiving) task. By using above applications, we made experiments and compared several schemes in terms of both the time and space efficiency.

3.2 Experimental Results and Evaluation

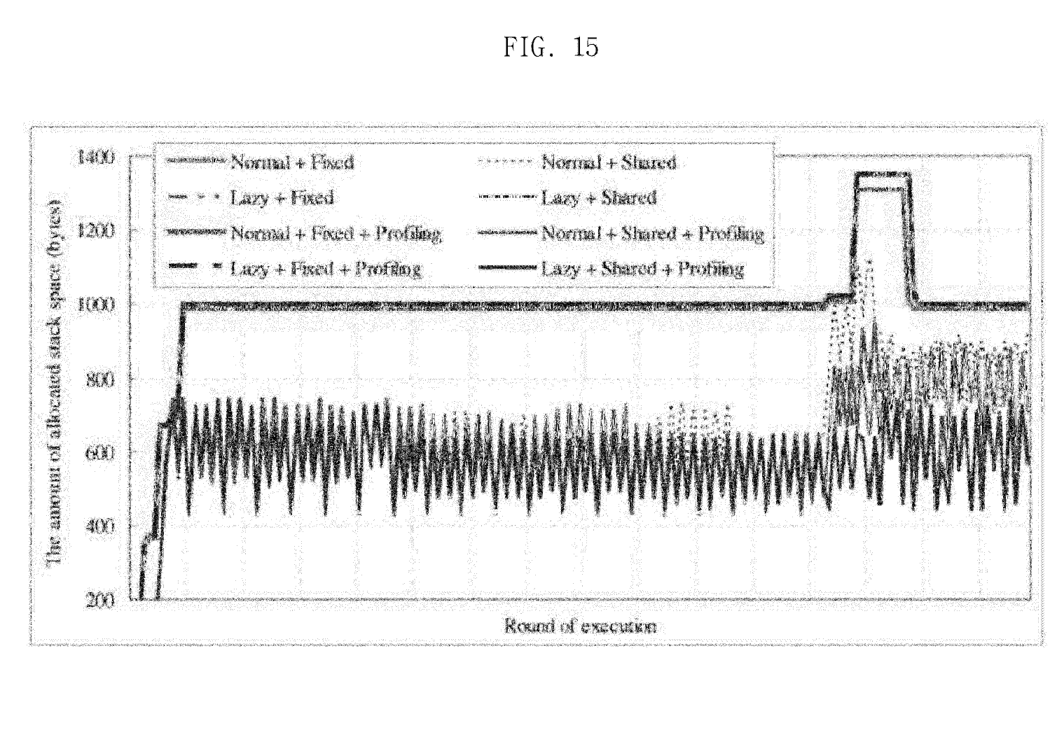

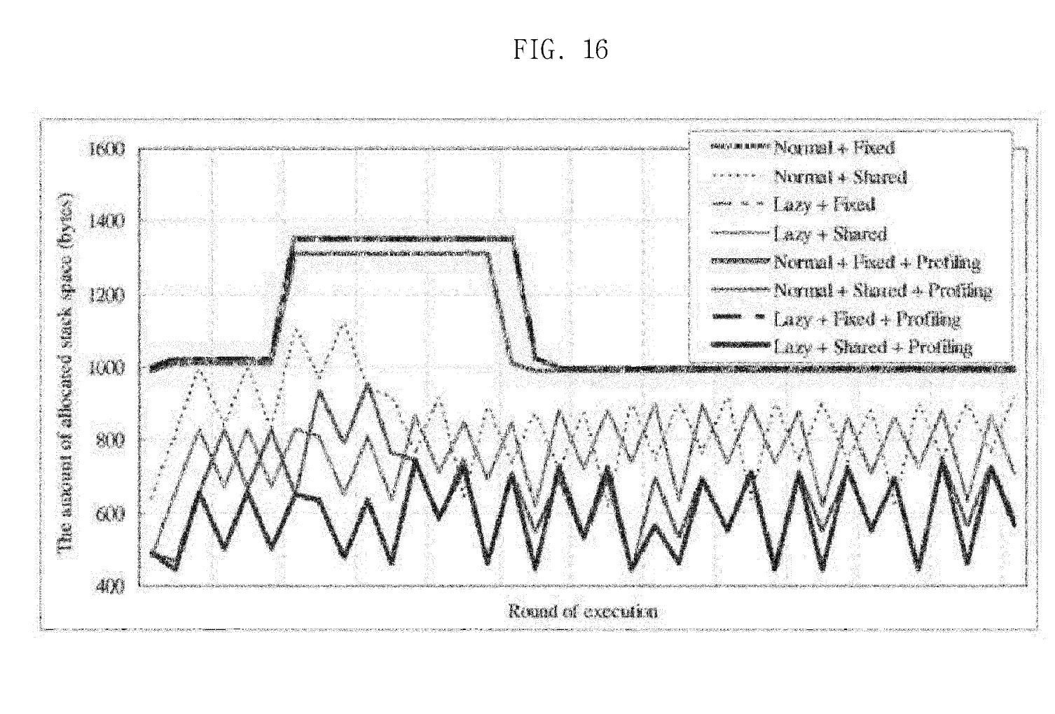

FIGS. 15 and 16 show amounts of allocated stack space for a sensor node according to an embodiment of the present invention.

First of all, we measured the amount of allocated stack space and the changes for 8 kinds of task management combinations. FIGS. 15 and 16 show the results over time for a sensor node.

In FIG. 15, using Fixed stack management performs much poorer than using Shared stack. Among the 4 combinations which uses the Shared stack management, using Profiling shows better than not using. Also Lazy round-robin scheduler shows smaller amount of stack usage than the Normal round-robin.

FIG. 16 shows the impact of task creation on the stack usage in detail. FIG. 16 shows results focused on creating and removing a task at run-time) From the results, the combination of Lazy, Shared, and Profiling shows better space-efficiency than almost all other combinations. In addition, the Lazy round-robin shows significant impact on the maximum stack space usage because it may exclude stack allocation for short-term tasks by providing delayed context switching.

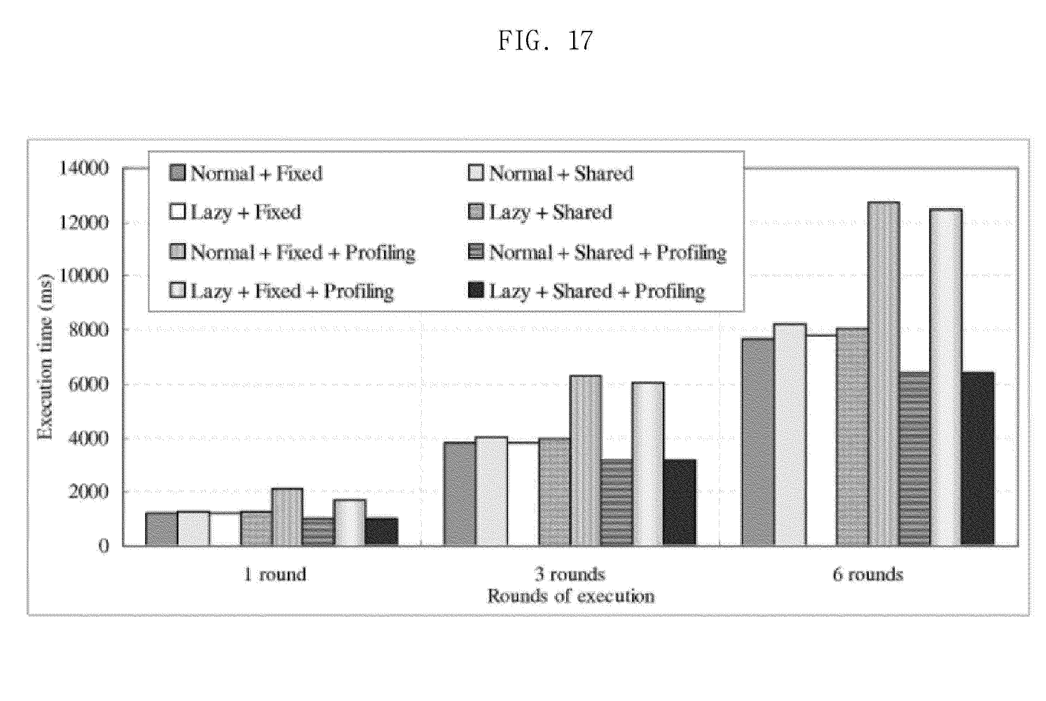

FIG. 17 shows total execution time for a sensor node according to an embodiment of the present invention.

The total execution time and the number of task context switching when using each task management scheme for a sensor node are also compared. From FIG. 17, we can observe that the combination of Shared stack and Profiling significantly reduces the total execution time.

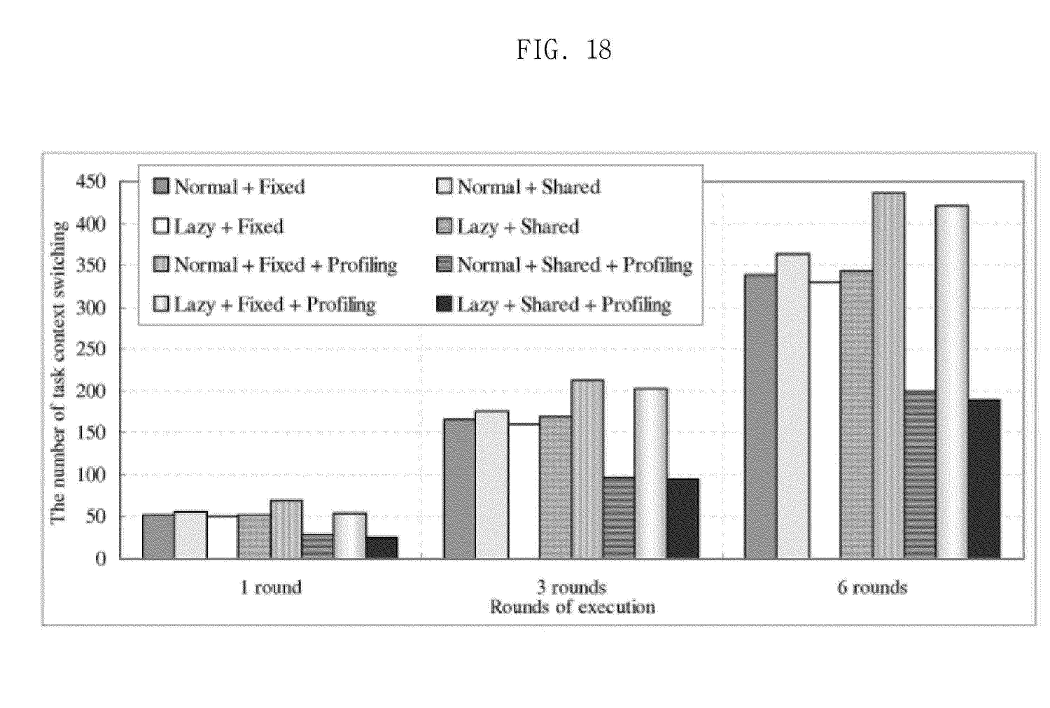

FIG. 18 shows Number of Context Switching Between Tasks for a sensor node according to an embodiment of the present invention.

FIG. 18 shows the number of context switching between tasks. From these results, we can observe that the Lazy round-robin scheduling mechanism does not have significant impact on the time-efficiency, because it can reduce only small number of context switching.

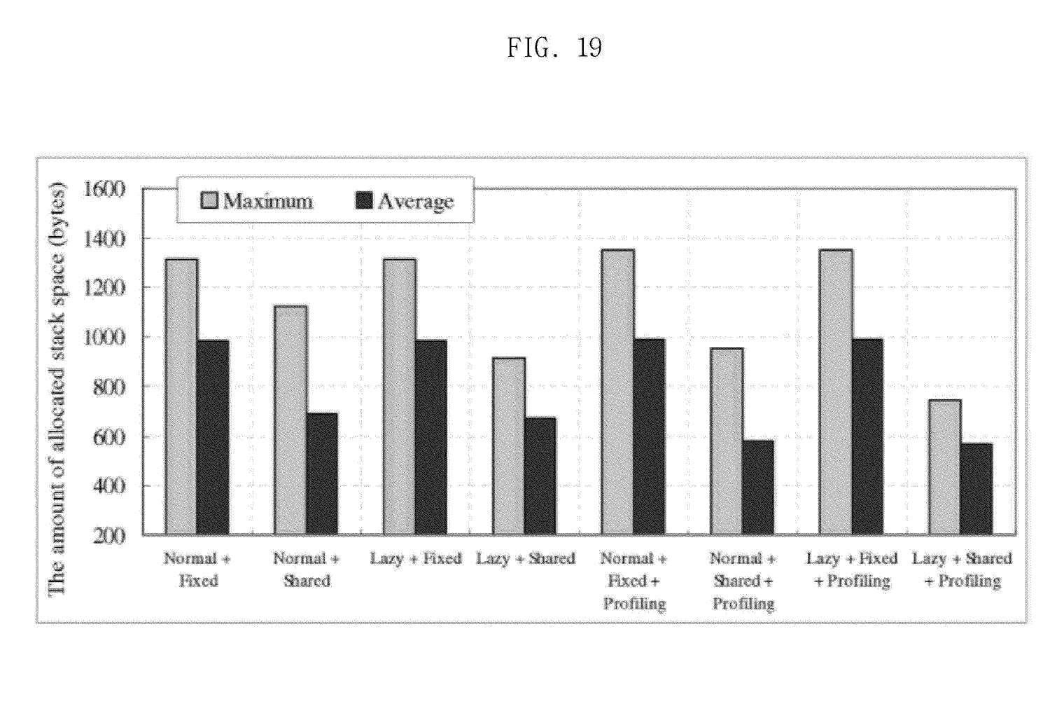

FIG. 19 shows Amount of Allocated Stack Space for a sensor node according to an embodiment of the present invention.

The present invention also focuses on the worst-case and the average stack usage of the task management schemes. FIG. 19 shows the results focusing on the maximum and the average amount of allocated stack space for a sensor node. In the results, the combination of Shared and Profiling reduces the stack usage about 30%, and the Lazy round-robin also reduces the stack usage about 25%. From FIG. 19, we can observe that all of three mechanisms (Lazy, Shared, and Profiling) may significantly reduce the maximum and the average stack usage.

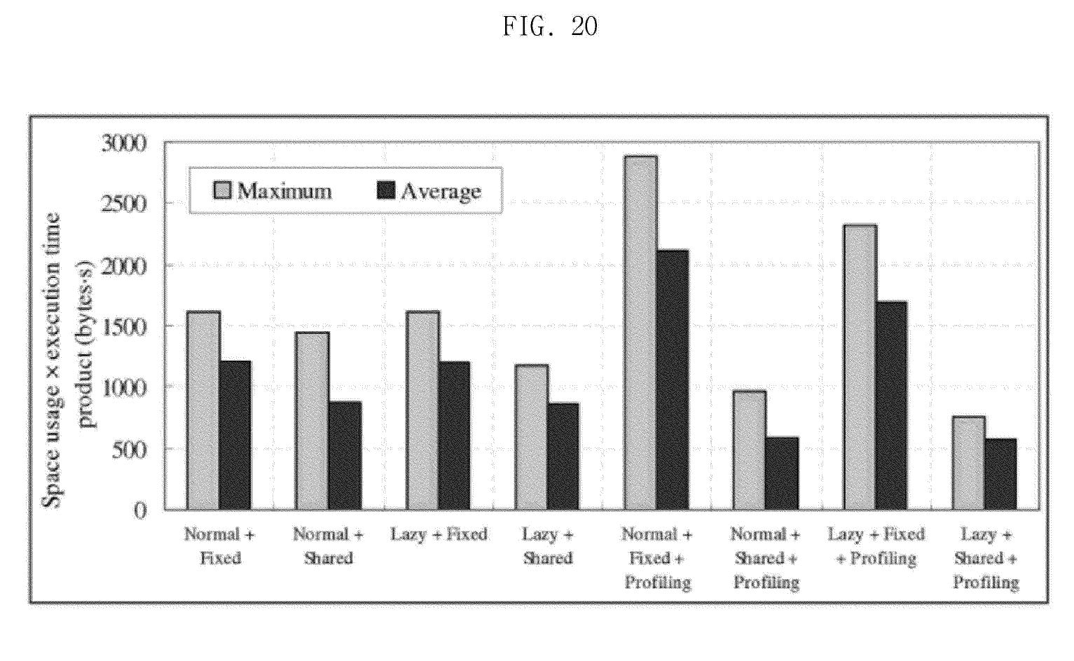

FIG. 20 shows space-time product for a sensor node according to an embodiment of the present invention.

FIG. 20 shows the summary of the performance evaluation. In this figure, the results show the product of space and time-efficiency for all combinations. Based on the results, it can be seen that the combination of Lazy, Shared, and Profiling will significantly improve performance and efficiency both space and time of existing sensor computing platforms.

In the present invention, we presented why both the event-driven and the multi-threaded are not enough to implement efficient embedded operating systems. Based on the reasons why they are inefficient, a new task management, eThread, which is designed for the resource-constrained embedded systems, is proposed. the prototype version of eThread on Nano-Qplus sensor operating system is implemented, and experiments on the well-known Tmote Sky sensor platforms are made. Our experimental results showed that eThread provides much better efficiency and performance compared with the existing task management schemes.

Automatic stack space profiling and source codes modification toolkits for the eThread is implemented. We are currently extending our work to analyze the impact of the Lazy round-robin scheduler and Profiling-based context switching scheme on schedulability of real-time embedded systems. We are also interested in selecting better policies and parameters for above scheduling and context switching schemes.

As described above, the system and method for inputting characters in a touch-based electronic device according to the present invention can be implemented with program commands that can be conducted via various types of computers and recorded in computer-readable recording media. The computer-readable recording media contain program commands, data files, data structures, or a combination thereof. The program commands recorded in the recording media may be designed or configured to comply with the present invention or may be software well-known to the ordinary person skilled in the art.

The computer-readable recoding media includes hardware systems for storing and conducting program commands. Examples of the hardware systems are magnetic media such as a hard disk, floppy disk, a magnetic tape, optical media such as CD-ROM and DVD, Magneto-Optical Media, such as floptical disk, ROM, RAM, and flash memory. The program commands include assembly language or machine code complied by a complier and a higher level language interpreted by an interpreter. The hardware systems may be implemented with at least one software module to comply with the present invention.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A task management method for an embedded system, comprising:
designing a task management according to a short term task and a long term task;
managing stack spaces for the short term task and the long term task;
scheduling a time and a space for the short term task and the long term task;
performing an adaptive stack management based on stack profiling;
providing a uniform programming model for the short term task and the long term task; and
implementing the short term task and the long term task.

2. The task management method of claim 1, wherein the designing comprises:
designing the task management based on Time slice management, Stack space management, Context switching, Programming method, and Complexity minimization.

3. The task management method of claim 1, wherein the scheduling is performed by a Lazy Round-Robin scheduling mechanism.

4. The task management method of claim 1, wherein the adaptive stack management is performed by a PreeMe-X, which provides both energy and space-efficient preemptive task managements.

5. The task management method of claim 1, wherein the short term task is a transient task which is similar to an event, and the long term task is a general task which is similar to a thread.

6. The task management method of claim 1, wherein the implementing comprises switching prototypes for the event and the thread.

7. The task management method of claim 6, wherein the switching comprises switching prototypes for a Task management component, a Stack space management component, a Stack usage profiling component, a programming interface, and a dynamic component.

8. The task management method of claim 6, wherein the switching comprises:
modifying source codes of Nano-Qplus and modifying each newly added component by dynamic kernel configuration utility.

9. The task management method of claim 8, wherein the switching comprises:
adding two variables (nExec, nThres) into each task structure to implement Lazy-RR and adaptive context switching based on a stack usage information,
wherein the nExec denotes how many times a task has been scheduled by a processor and the nThres is used for denoting threshold value of each task's stack usage.

10. The task management method of claim 9, wherein the stack usage of a running task is larger than nThres, a context switching is skipped and retried at a next context switching point, and if the context switching is skipped for a reasonable duration, a scheduler performs context switching between tasks,
wherein the reasonable duration is set as an amount of a default time slice.
